(19) United States
(12) Patent Application Publication
(10) Pub. No.: US 2008/0127089 A1
(43) Pub. Date: May 29, 2008

(54) Method For Managing Software Lifecycle

(76) Inventors: Zohar Peretz, Tel-Aviv (IL); Rami Azulay, Tel-Aviv (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/470,661

(22) Filed: Sep. 7, 2006

(51) Int. Cl. G06F 9/44

(52) U.S. Cl. 717/122

(57) ABSTRACT

A method for managing software life cycle is provided. The method provides a multi-user distributed environment supporting the proactive management of a software life-cycle for at least one stakeholder. The method includes the steps of: obtaining and analyzing requirement information, generating test plans, creating WBS documents, storing and managing life cycle historical information, supplying online workflow-based notifications and messages and providing role-based customized functionality.

### FIELD OF THE INVENTION

The present invention relates to an integrated system and method for managing software life cycle, provides source-code integration management, allows event-driven actions including control of workflow and enabling role-based customized functionality and information sharing.

### BACKGROUND OF THE INVENTION

A life cycle begins with an idea or a need that can be satisfied wholly or partly by software and ends with the retirement of the software. According to industry standards (ISO 12207) architecture is comprised of a set of processes and interrelationships among these processes. The primary set of processes serves the key parties involved in the acquisition, supply, development, operation and maintenance of software. During the acquisition process, system requirements are defined, typically by the user or the client. After the requirements' definitions were completed, the development process is initiated. During this stage, the system analysts, architects and programmers translate the requirements into code and the software project is tested. Specific tests are defined and executed on the software, thereby verifying that the system meets the defined requirements and runs correctly. Once the product is ready, it is deployed at the end user site, and the user receives ongoing support from the software company.

During all stages of the lifecycle there is a need to manage the correction of defects and the changes made to the product source code or specifications, at multiple end user sites.

A common problem on many projects is scope creep, a tendency that can cause serious problems if the requirements change and the entire team is not made aware of it. “Scope creep” might cause costly rework; Dissatisfied customers when a promised feature was not available to them on time, schedule delays on other projects when resources that were expected to be delivered is not ready and serious criticism on the side of the developers.

Another common problem is failing to practice quality assurance as a process, and rather see it as a set of product tests. Poor communication between team members and lack of information about the test results might lead to excessive testing time, dissatisfied customers, expensive rework and inferior product quality.

Another common problem, is failing to detect abnormal behavior of the system functionality or performance, generally referred to as “genetic fault. Many systems consist of sensitive areas, where even minor changes may cause other areas to work improperly. Lack of information regarding such behavior may result in excessive testing of wrong software areas, thereby reducing software quality and reliability.

### SUMMARY OF THE INVENTION

The present invention is directed at addressing the above-mentioned shortcomings, disadvantages and problems of the prior art. It enables the IT organization to perform real-time monitoring and management of its software project, utilize accumulated knowledge, have a “drill-down” capability to identify problems as early as possible in each software project's lifecycle and make reduction of the overall time feasible.

Broadly stated, the present invention is directed to a software project management system for enabling at least one stakeholder to manage information regarding a software project that includes the generation of at least one task for an end user, comprising: a product management processor supporting the lifecycle of a software project for prompting at least one participant to perform a plurality of actions such that the at least one participant is guided through a set of relevant tasks for supporting the lifecycle of a software project and for enabling at least one stakeholder to monitor and oversee the project and the progress of the software project generation for the project; a user interface for enabling role-based access to the software project management system for the at least one participant and the at least one stakeholder and for enabling the at least one participant and the at least one stakeholder to input data to the product management processor and access data from the lifecycle according to the role-based access. Broadly stated, the lifecycle support process comprises the steps of: prompting the participant to identify the interrelations between software project entities and a set of actions that need to be performed if one of the objects related to the entities is changed; a software project entity can be described as any digital document related to the software developed, such as a software requirement, a WBS item, a source code, a graphic or audio item, a script; prompting the participant with a pre-defined online action if any change made to one of the relevant items is described; running a pre-defined batch action whenever a relevant change made to any of the software project entities, such as commencing a test plan, updating database, generating a report, sending a notification.

The object of the present invention is that it provides a support to a software project lifecycle management for enabling at least one stakeholder to manage at least one or more software projects and for guiding a participant through a set of tasks generated automatically for each change within the project entities and for also enabling the stakeholder to monitor and oversee the progress thereof.

One advantage of the present invention is that it enables real-time software project status monitoring for identifying authority, accountability and responsibility for each of the changes performed within the project entities. Tracking changes made by any of the users and informing all other relevant stakeholders about the changes and changes impact, increases transparency and information flow and decreases the number of inconsistencies typically found in the development process, makes information flow optimal. The product end-user can automatically inform the support team of problems in the deployed system, cutting back on the time required to transmit this information and on the time required to fix these problems. A proactive alert server is provided to support automatic task executions, based on pre-defined events.

Another advantage of the present invention is that it provides a “dashboard” that provides customized functionality for everyone from an executive stakeholder to a program generator/participant. A secure role-based access to different views of a software project in the process of being generated is also provided. The dashboard contains a messaging center where all alerts and notifications are archived and tracked.

Another advantage of the present invention is that it provides an improved accessibility to 3^{rd} party programs responsible for generating automatic batch software tests, based on pre-defined scripts.

Another advantage of the present invention is that it provides automatic execution of test plan scripts whenever specific code has been used to fix a defect or when a programming task is completed. If the same code file is used to fix different codes or defects, even later in the lifecycle, the system identifies these relations and automatically generates an execution set that includes the new change and all other objects related to the same code file.

Another advantage of the present invention is that it provides graphic project management tool comprises of Gantt charts, updated automatically based on the data generated by the system. The Gantt is presented per user as well, allowing stakeholder to analyze the volume of work each employee is dealing with and allocate resources respectively. Furthermore, the system supports impact analysis on the overall delivery time, if any of the said items were changed, supporting decision making regarding the approval of the said changes.

Yet another advantage of the present invention is that it provides version management of said software project entities, such as requirement, defects and test plans that empower the user ability to distinguish between one change to another on the course of the product life cycle. Furthermore, the system allowing authorized stakeholders to lock the version content and restrict entity changes only to users pre-defined within the workflow procedures. Moreover, the system allows the generation of periodic reports and summary reports, whenever a specific action is initiated.

Another advantage of the present invention is that it provides a full standard work flow management tool that handles both batch and online rule based actions. The workflow engine supports complex information flow through the system, allowing role-based accessibility to software project entities and standard common user interface. The rule base workflow mechanism allowing logical task flow and automation of software project life cycle processes, during which events are passed from one state to another, according to a set of rules defined by the workflow scheme.

Another advantage of the present invention is that it supports knowledge transfer between stakeholders, allowing parties to communicate and control work plan changes and development failures adjacent to their detection thereby optimizing lifecycle processes by reducing manual electronic messaging and improving information flow within the organization.

Another advantage of the present invention is that it supports resource optimization, allowing stakeholders to appoint most suitable employee for a critical job, based on accumulated data stored in the product system management.

Yet Another advantage of the present invention is that it stores dynamic relations between software project items using interactive traceability matrix thereby improving life cycle control and management and supporting software project documentation.

Yet Another advantage of the present invention is that it supports data mining of accumulated information stored in the product system management, allowing stakeholders to analyze historical life cycle evolution thereby improving future projects' development and increasing organization efficiency. At the same time the historical information is being used to identify potential failure of the system in areas where abnormal behavior is being identified, based on certain criteria such as code, defects and specifications.

### BRIEF DESCRIPTION OF THE DRAWINGS

FIG. 1 represents the standard software primary life cycle (ISO 12207) comprised of 5 distinguished processes.

FIG. 2 represents a general description of an event flow.

FIG. 3 represents a schematic interconnection between roles (303), events (302) and requirement item (301) defined within the acquisition process (101).

FIG. 4 represents a schematic interconnection between roles (e.g. project manager) (405), events (e.g. WBS item changed) (402) and support plan entities (401) defined within the supply process (102).

FIG. 5 represents a schematic interconnection between roles (e.g. developers, QA experts) (703), events (e.g. bugs), (702) and entities (e.g. source code) (701) defined within the development process (105).

### DETAILED DESCRIPTION OF THE INVENTION

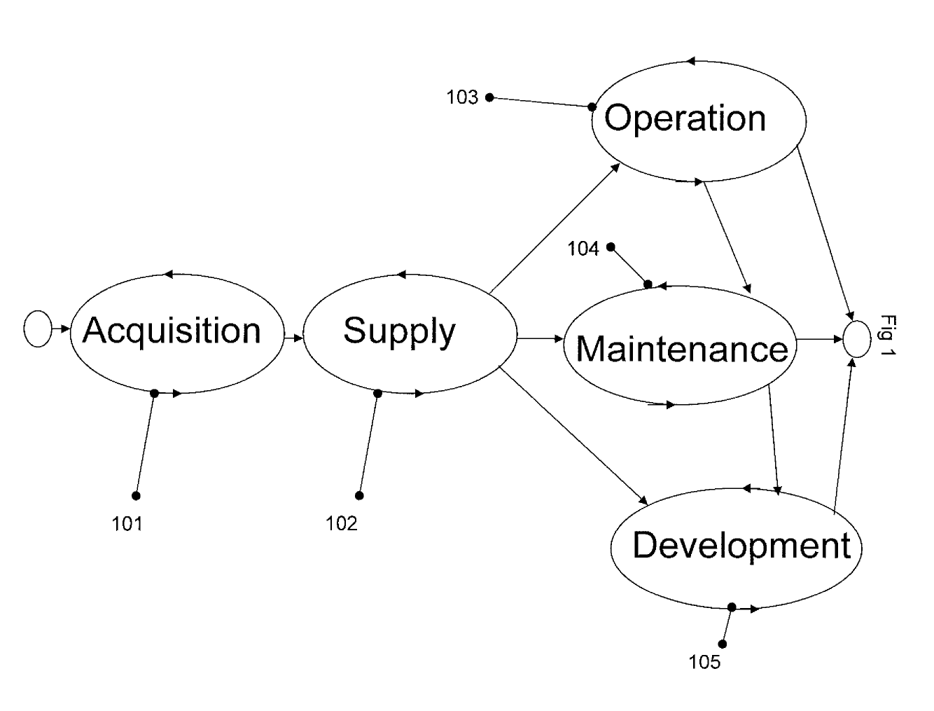

A user of software project management system (FIG. 1, 100) typically has, but is not limited to, at least one of the following roles in an IT organization and also any software development process: Senior Management, Application managers, Developers, IT architects, Process managers, Product managers, Program managers, Quality Assurance (“QA”) managers, testers and Technical managers or any other role as designated by the IT organization. The software project management system according to the preferred embodiment of the present invention is not limited to use by users in an IT organization, but can also be used in any software development process. Typically, a participant/program member is associated with at least one program being generated, but may be associated with multiple programs in the IT organization's “programs in process” portfolio. A stakeholder is typically a Senior Management, the IT organization management, a Program Manager, and representatives of the IT organization, as designated. An end user is any individual or any entity that will use the program once it is released, and may include customers and clients of the IT organization.

Software project management system also comprises a user interface for enabling the participant and the stakeholder to input data in response to at least one request for data from the product management processor as the program guides the participant through the lifecycle process. The user interface is enabled through the use of an industry standard personal computing system, such as a desktop or a laptop computer.

The primary life cycle consist of 5 main processes. During each of these processes, plurality of events can be defined to represent changes mandated by the user requesting the service.

FIG. 1 is a schematic diagram of the primary life cycle flow. The primary life cycle consists of 5 main processes: The Acquisition Process (101), The Supply Process (102), the operation process (103), The maintenance process (104) and the Development process (105). For each one of these processes, plurality of events can be assigned by the system user (100) to manage content change.

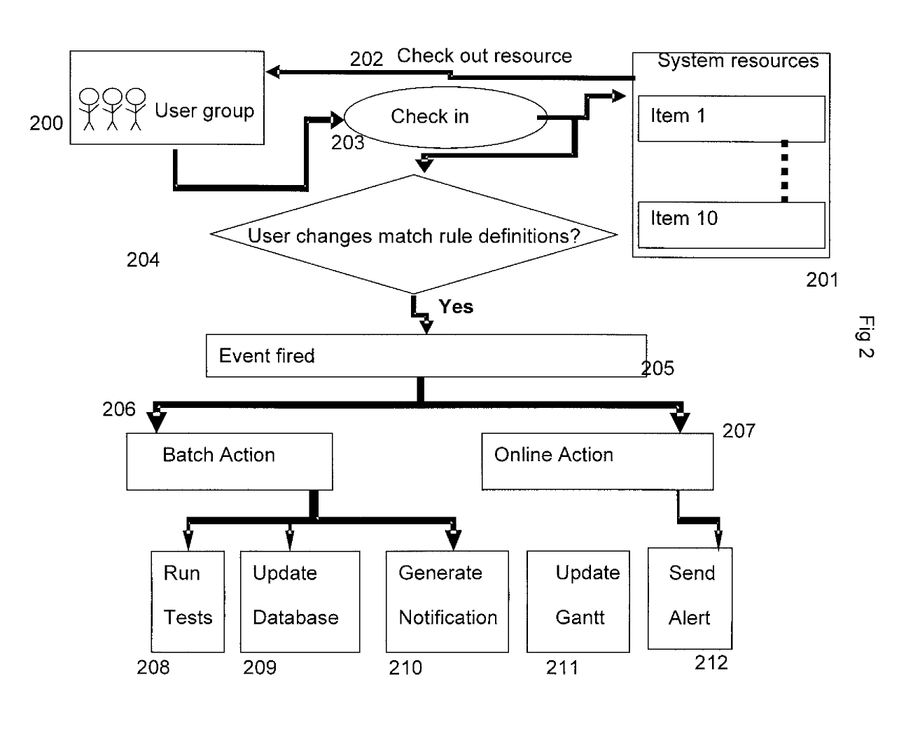

FIG. 2 is a block diagram that illustrates the principal functionality of the product management system. In essence, a product is comprised of one or more digital formatted file (201) which can be regarded as the software project entity. A project entity can typically be, but not limited to, one of the following types: Requirement items, source code file, graphic and audio files, WBS items, test plan scripts. As part of the life cycle process, authorized users create and update software project entities. In order to update said entity, user must “check out” (202) the file, in order to avoid version conflicts. When file is ready to be placed back, user initiates a “check in” (203) action. Once “check in” action is commenced, the product management process checks to see if any actions were assigned to be initiated upon entity change (204) in accordance with predefined rules. If such actions were found, a new event is fired (205) and the workfiow engine activates pre-defined actions. An action can typically be, but not limited to, one of the following types: batch test plan (208), database update (209), notification generation (210), Gantt Update (211) and pro-active alert (212). The predefined rules are defined and dynamically updated by a system manger enabling to determine software project management processing and priorities. The predefined rules also represent the inner relationships between software project entities.

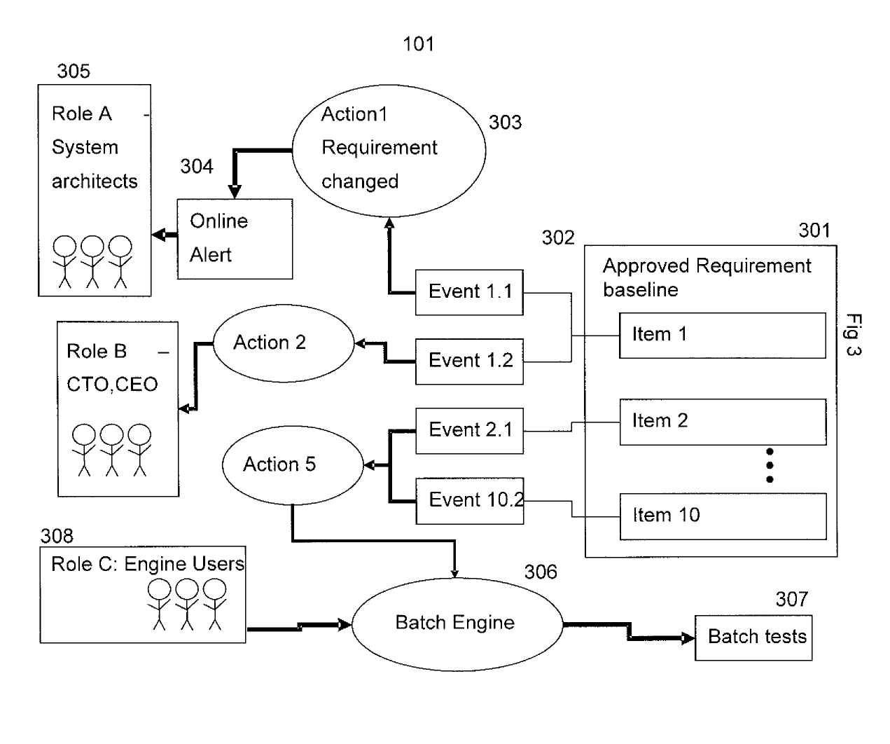

FIG. 3 is a schematic diagram that exemplifies a scenario when an action is set to a requirement document (301), which is a part of the acquisition process. The Acquisition Process (101) defines the activities and tasks of the acquirer, which contractually acquires software product or service. Events defined for this stage will fire process actions to notify all stakeholder of changed request. As soon as the requirement documents were completed (301), project manager, or any other individual designated for this job, identifies the actions that must take place in the future, when any part of said documents should be changed. If, for example, the project manager wants to be notified whenever such a change is made, he will attach a new event (302) to the specified requirement. Once the requirement is changed (303), action is commenced and an online alert (305) is sent to all the attendee. Alternatively, a user can assign a batch action as well. The project manager can assign a set of test plans to take place, whenever a specified requirement is changed. Thereby, once the requirement is changed by any of the users, the workflow engine (306) commences the said plan (307), through special batch users registered to that engine (308).

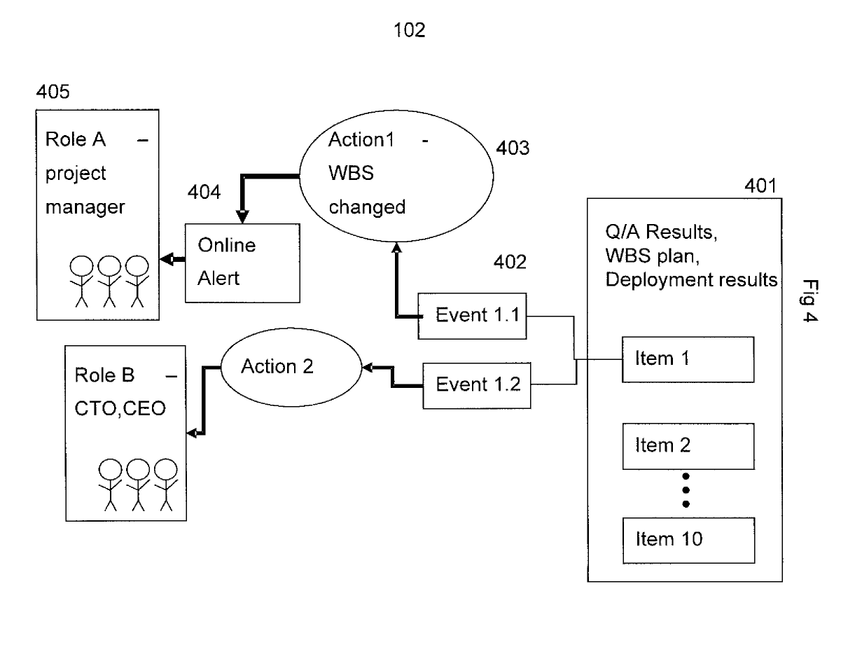

FIG. 4 is a schematic diagram that exemplifies a scenario when an action is set to a WBS item, which is a part of the supply process. The Supply Process (102) contains the activities and tasks of the supplier. It consists of the following activities along with their specific tasks: Initiation; Preparation of response; Contract; Planning; Execution and control; Review and evaluation; and Delivery and completion. Project manager can assign online alert action to be commenced whenever a WBS item is changed by one of the users. For example, whenever a Gantt is changed, workflow initiates a new system process that drives through the specified actions, and sends alerts (404) to the pre-defined users (405).

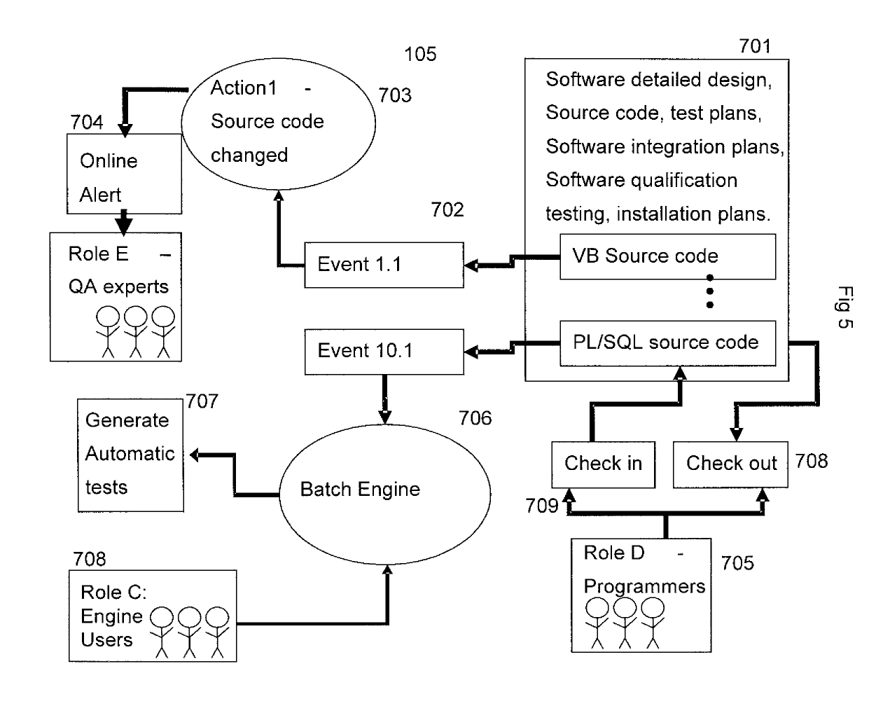

FIG. 5 is a schematic diagram that exemplifies a scenario when an action is set to source code update. The development process consists of the following activities along with their specific tasks. Process implementation; System requirements analysis; System design; Software requirements analysis; Software architectural design; Software detailed design; Software coding and testing; Software integration; Software qualification testing; System integration; System qualification testing; Software installation; and Software acceptance support. Project manager, for example can assign batch test scripts to run whenever an update was made to one of the software project entities (701). In order to update any of the said source code entities (701), developers (705) must “check out” (708) it first. The version content manager allows content update only to the specified user who checked out the source. After program were manually tested and found to be running properly, the version content manager allows the developer to check it back in and stores a history of changes made for future reference. The said test plans (707) is commenced by the workflow engine (708) immediately after the entity were checked in.

An advantage of the present invention is that the product management processor and the user interface are preferably configured to enable real-time program status monitoring for identifying authority, accountability and responsibility for each task that is to be performed in the lifecycle process. This is enabled by designing the product management process to generate a dashboard, preferably through http URL pages, for everyone from the stakeholders to the participant/program members, wherein a secure role-based access to different views of the software project's status may be obtained.

Another feature of the present invention is that the product management processor enable data mining and decision support functionality providing collection and generation of important historical data. This data can be used by stakeholders to analyze project critical development path and employees' efficiency. Furthermore, the system enables the detection of abnormal software functionality and performance and allows the location of genetic fault symptoms.

A genetic fault describes the anomalies found in specific entities during the software lifecycle. System analysis enables the location of faults' possible causes and supplies alternative recommendations for solving or avoiding said faults. A common example for such faults is given in the scenario when the quantity of defects found in a module increases with each new version, accompanied by multiple module updates. Such updates may demand the creation of new test plans. System recommendations will include the proposed new plans, such as, “write test to X module and assign user Y to run them”. Furthermore, the system may route the proposed activities to different resources, according to their availability and skill. If, for example, a resource (e.g. a programmer) is too busy, the system will generate a notification, such as “user X is too loaded”, A genetic fault may also be defined as a specific deviation from predefined rules, such as “amount of active defects in critical modules is above 75%”. The system also enables to define failure probability for each module in the system; to declare specific activities completion; to produce QA work plan for each release due to changes and links and other relevant data; and more.

The system for project product management described in the text above was chosen as being illustrative of the best mode of the present invention. All embodiments of the present invention described above all illustrative of the principles of the invention and are not intended to limit the invention to the particular embodiments described. Accordingly, while the preferred embodiment of the invention has been illustrated and described, it will be appreciated that various changes can be made therein without departing from the spirit and scope of the invention as claimed.

What is claimed is:

1. A software product management system for software project of multi user distributed environment providing services of notification, work plan and active cooperation knowledge, wherein said services relate to the soft project complete lifecycle, said system is comprised of:
active change management module for monitoring software project entities content changes in accordance with pre-defined events
work flow management module enabling knowledge transfer between users in accordance with monitored software project entities changes
notification alert module providing action to perform in accordance with monitored software project entity changes based on predefined rules;

2. The system of claim 1 further comprising an automatic work plan generation module based software project entity changes and predefined rules.

3. The system of claim 2 wherein the automatic work plan generation module include entity optimization.

4. The system of claim 1 wherein the predefined rules represent dynamic relation between software project entities.

5. The system of claim 1 further comprising interface module providing compatibility with external systems including at least one following type of external systems: test system, requirement management system, CRM system and bug handling system.

6. The system of claim 1 wherein all system definition can be dynamically updated, said definitions include at least one of the following: events, rules, action, alert messages and distribution list of alerts relation.

7. The system of claim 1 further comprising a data mining engine module for retrieving old projects management data;

8. The system of claim 1 further comprising a decision support module providing at least one service of: budget deviations predictions, effectiveness of testers, enables the detection of abnormal software functionality and performance and the finding of genetic fault symptoms.

9. The system of claim 1 further comprising a multi-version content management module, recording old version of program entities and enables entering old and new version view at any time.

10. The system of claim 1 wherein the program entities include at least one of the following: requirement entities, source code documents, graphic and audio files, WBS items, test plan scripts, test definition, defects, design documentation.

11. The system of claim 1 wherein the events includes external systems events.

12. A software product management method for software project of multi user distributed environment providing services of notification, work plan and active cooperation knowledge, wherein said services relate to the soft project complete lifecycle, said method comprising the steps of
monitoring software project entity content changes in accordance with pre-defined events
knowledge transferring between users in accordance with monitored software project entity changes;
notifying alerts which acknowledge action to perform in accordance with monitored software project entity changes based on predefined rules;

13. The method of claim 12 further comprising the step of generating an automatic work plan based on software project entity changes and predefined rules.

14. The method of claim 13 wherein the automatic work plan generation include entity optimization.

15. The method of claim 12 wherein the predefined rules represent dynamic relation between software project entities.

16. The method of claim 12 further comprising the step of dynamically updating, system definition including at least one of the following: events, rules, action, alert messages and distribution list of alerts relation.

17. The method of claim 12 further comprising the step of retrieving old projects management data;

18. The method of claim 12 wherein the program entities include at least one of the following: requirement entities, source code file, graphic and audio files, WBS items, test plan scripts, test definition, defects, design documentation.

19. The method of claim 12 wherein the events includes external systems events.
